(19) United States
(12) Patent Application Publication
(10) Pub. No.: US 2012/0280169 A1
(43) Pub. Date: Nov. 8, 2012

(54) Thermally Conductive Silicone Grease Composition

(76) Inventors: Tomoko Kato, Ichihara-shi (JP); Kazumi Nakayoshi, Sodegaura-shi (JP)

(21) Appl. No.: 13/520,144

(22) PCT Filed: Jan. 7, 2011
(86) PCT No.: PCT/JP2011/050611

§ 371 Date: Jun. 29, 2012

(30) Foreign Application Priority Data
Jan. 7, 2010 (JP) JP2010-002094

(51) Int. Cl. C09K 5/00

(52) U.S. Cl. 252/75; 252/78.3

(57) ABSTRACT

A thermally conductive silicone grease composition comprises: (A) an organopolysiloxane represented by the following general formula: wherein each R¹ is independently selected from monovalent hydrocarbon groups, each X is independently selected from monovalent hydrocarbon groups or alkoxysilyl-containing groups of the following general formula: —R²—SiR¹ₐ(OR³)₍₃₋ₐ₎ wherein R¹ is defined as above, R² is an oxygen atom or an alkylene group, R³ is an alkyl group, a is an integer ranging from 0 to 2, m is an integer equal to or greater than 0, and n is an integer equal to or greater than 0; (B) a thermally conductive filler; and (C) an aluminum-based or titanium-based coupling agent. The composition exhibits excellent heat resistance and reduced oil bleeding.

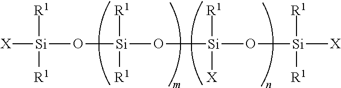

### TECHNICAL FIELD

The present invention relates to a thermally conductive silicone grease composition.

Priority is claimed on Japanese Patent Application No. 2010-2094, filed on Jan. 7, 2010, the content of which is incorporated herein by reference.

### BACKGROUND ART

Accompanying the increase in recent years in the density and level of integration of hybrid ICs and printed circuit boards mounted with electronic components such as transistors, ICs, memory elements, and so forth, thermally conductive silicone grease compositions comprising an organopolysiloxane and a thermally conductive filler, e.g., aluminum oxide powder, zinc oxide powder, and so forth, are being used for the purpose of very efficiently dissipating the heat generated by these electronic components (see Japanese Unexamined Patent Application Publications (hereinafter referred to as “Kokai”) Sho 50-105573, Sho 51-55870 and Sho 61-157587).

A problem with these thermally conductive silicone grease compositions, however, is that a portion of their oil component bleeds out, which causes a decline in electronic component reliability.

In addition, in order to achieve a high loading level by the thermally conductive filler in the thermally conductive silicone grease composition, a thermally conductive silicone grease composition has been proposed that comprises an organopolysiloxane, a thermally conductive filler, and an organohydrogenpolysiloxane having at least three silicon-bonded hydrogen atoms in each molecule (see Kokai Hei 04-202496).

One problem with such a thermally conductive silicone grease composition, however, is its heat resistance, i.e., when applied in a thick layer or when coated on a vertical surface, it exhibits fluidity upon the application of heat. Another problem is the occurrence of oil bleeding.

It is an object of the present invention to provide a thermally conductive silicone grease composition that exhibits excellent heat resistance and reduced oil bleeding.

### DISCLOSURE OF INVENTION

The thermally conductive silicone grease composition of the present invention comprises:
(A) 100 parts by mass of an organopolysiloxane represented by the following general formula:

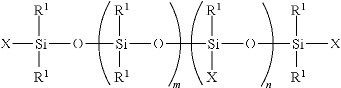

wherein

each R¹ is independently selected from monovalent hydrocarbon groups,

each X is independently selected from monovalent hydrocarbon groups or alkoxysilyl-containing groups represented by the following general formula:

—R²—SiR¹ₐ(OR³)₍₃₋ₐ₎
wherein
R¹ is defined as above,
R² is an oxygen atom or an alkylene group,
R³ is an alkyl group, and
a is an integer ranging from 0 to 2,

m is an integer equal to or greater than 0, and

n is an integer equal to or greater than 0;
(B) 500 to 4,500 parts by mass of a thermally conductive filler; and
(C) 1 to 100 parts by mass of an aluminum-based or titanium-based coupling agent.

### EFFECTS OF INVENTION

The thermally conductive silicone grease composition of the present invention is characterized by excellent heat resistance and by reduced oil bleeding.

### DETAILED DESCRIPTION OF THE INVENTION

The organopolysiloxane of component (A) is a base component of the composition and is represented by the following general formula:

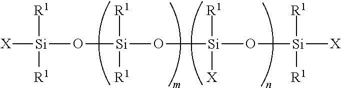

In the above formula, each R¹ is independently selected from monovalent hydrocarbon groups. R¹ may be exemplified by linear-chain alkyl groups such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, and so forth; branched-chain alkyl groups such as isopropyl, tertiary-butyl, isobutyl, 2-methyl undecyl, 1-hexyl heptyl, and so forth; cyclic alkyl groups such as cyclopentyl, cyclohexyl, cyclododecyl, and so forth; alkenyl groups such as vinyl, allyl, butenyl, pentenyl, hexenyl, and so forth; aryl groups such as phenyl, tolyl, xylyl, and so forth; aralkyl groups such as benzyl, phenethyl, 2-(2,4,6-trimethylphenyl)propyl, and so forth; halogenated alkyl groups such as 3,3,3-trifluoropropyl, 3-chloropropyl, and so forth. Most preferable are alkyl, alkenyl, or aryl groups, especially methyl, vinyl, or phenyl groups.

In the above formula, each X is independently selected from monovalent hydrocarbon groups or alkoxysilyl-containing groups represented by the following general formula:

—R²—SiR¹ₐ(OR³)₍₃₋ₐ₎

The monovalent hydrocarbone groups designated by X may be the same as aforementioned groups designated by R¹, of which preferable are alkyl, alkenyl, and aryl groups, especially methyl, vinyl, or phenyl groups. In the alkoxysilyl-containing groups, R¹ is the same as those mentioned above and preferably is an alkyl group, especially methyl group. R² is an oxygen atom or an alkylene group such as ethylene, propylene, butylene, methylethylene, and so forth, wherein ethylene and propylene are preferred. R³ is an alkyl group and can be exemplified by methyl, ethyl, propyl, butyl, and so forth, wherein methyl and ethyl are preferred. a is an integer ranging from 0 to 2 and is preferably 0.

In the above formula, m is an integer equal to or greater than 0, and n is an integer equal to or greater than 0. Although there are no limitations on the viscosity of component (A) at 25° C., it is preferably in the range from 5 to 100,000 mPa·s and particularly preferably is in the range from 5 to 50,000 mPa·s. The reasons for this are as follows: the sedimentation and separation of component (B) during storage of the obtained composition can be inhibited when the viscosity at 25° C. is at least the lower limit on the indicated range; on the other hand, the obtained composition exhibits excellent handling characteristics when the viscosity at 25° C. is not more than the upper limit on the indicated range. The sum of m and n in the formula is therefore preferably a value that provides component (A) with the viscosity at 25° C. in the previously indicated range.

Component (A) can be exemplified by a dimethylpolysiloxane endblocked by trimethylsiloxy groups at both molecular chain terminals, a dimethylpolysiloxane endblocked by dimethylphenylsiloxy groups at both molecular chain terminals, a copolymer of a dimethylsiloxane and a methylphenylsiloxane endblocked by trimethylsiloxy groups at both molecular chain terminals, a copolymer of a dimethylsiloxane and a methylphenylsiloxane endblocked by dimethylphenylsiloxy groups at both molecular chain terminals, a methyl(3,3,3-trifluoropropyl)polysiloxane endblocked by trimethylsiloxy groups at both molecular chain terminals, a dimethylpolysiloxane endblocked by dimethylvinylsiloxy groups at both molecular chain terminals, a dimethylpolysiloxane endblocked by methylphenylvinylsiloxy groups at both molecular chain terminals, a copolymer of a dimethylsiloxane and a methylphenylsiloxane endblocked by dimethylvinylsiloxy groups at both molecular chain terminals, a copolymer of a dimethylsiloxane and a methylvinylsiloxane endblocked by dimethylvinylsiloxy groups at both molecular chain terminals, a copolymer of a dimethylsiloxane and a methylvinylsiloxane endblocked by trimethylsiloxy groups at both molecular chain terminals, a methyl(3,3,3-trifluoropropyl)polysiloxane endblocked by dimethylvinylsiloxy groups at both molecular chain terminals, a dimethylpolysiloxane endblocked by trimethoxysiloxy groups at both molecular chain terminals, a copolymer of a dimethylsiloxane and a methylphenylsiloxane endblocked by trimethoxysiloxy groups at both molecular chain terminals, a dimethylpolysiloxane endblocked by methyldimethoxysiloxy groups at both molecular chain terminals, a dimethylpolysiloxane endblocked by triethoxysiloxy groups at both molecular chain terminals, a dimethylpolysiloxane endblocked by trimethoxysilylethyl groups at both molecular chain terminals, a dimethylpolysiloxane endblocked by a trimethylsiloxy group at one molecular chain terminal and endblocked by a trimethoxysilylethyl group at another molecular chain terminal, a dimethylpolysiloxane endblocked by a dimethylvinylsiloxy group at one molecular chain terminal and endblocked by a trimethoxysilylethyl group at another molecular chain terminal, a dimethylpolysiloxane endblocked by methyldimethoxysilylethyl groups at both molecular chain terminals, a copolymer of a dimethylsiloxane and a methylphenylsiloxane endblocked by methyldimethoxysilylethyl groups at both molecular chain terminals, and mixtures of two or more of the above.

In particular, when an organopolysiloxane having at least one alkoxysilyl-containing group is used as component (A), this component then functions as a surface-treating agent for component (B). This has the effect of avoiding a deterioration in the handling properties of the obtained composition even at high levels of loading with component (B).

Component (B) is a thermally conductive filler for the purpose of imparting thermal conductivity to the composition. This component can be exemplified by metal-based powders such as those of gold, silver, copper, aluminum, nickel, brass, shape-memory alloys, solder, and so forth; powders as provided by plating or vapor depositing a metal, e.g., gold, silver, nickel, copper, and so forth, on the surface of, for example, a ceramic powder, glass powder, quartz powder, or organic resin powder; metal oxide-based powders such as those of aluminum oxide, magnesium oxide, beryllium oxide, chromium oxide, zinc oxide, titanium oxide, crystalline silica, and so forth; metal nitride-based powders such as those of boron nitride, silicon nitride, aluminum nitride, and so forth; metal carbide-based powders such as those of boron carbide, titanium carbide, silicon carbide, and so forth; metal hydroxide-based powders such as those of aluminum hydroxide, magnesium hydroxide, and so forth; carbon-based powders such as carbon nanotubes, carbon microfibers, diamond powder, graphite, and so forth; and mixtures of two or more of the above. In particular, metal-based powders, metal oxide-based powders, and metal nitride-based powders are preferred for component (B) with silver powder, aluminum powder, aluminum oxide powder, zinc oxide powder, and aluminum nitride powder being specifically preferred. When electrical insulation is required of the composition, metal oxide-based powders and metal nitride-based powders are preferred wherein aluminum oxide powder, zinc oxide powder, and aluminum nitride powder are particularly preferred.

The shape of component (B) is not particularly limited, and it may be, for example, spherical, acicular, disk shaped, rod shaped, or irregularly shaped, wherein spherical and irregularly shaped are preferred. Although there are no limitations on the average particle size of component (B), it is preferably in the range from 0.01 to 100 μm and more preferably is in the range from 0.01 to 50 μm.

The content of component (B) is in the range from 500 to 4,500 parts by mass, and preferably is in the range from 500 to 4,000 parts by mass, and particularly preferably is in the range from 500 to 3,500 parts by mass, in each case per 100 parts by mass of component (A). The reasons for this are as follows: the resulting composition exhibits an excellent thermal conductivity when the content of component (B) is at least the lower limit on the indicated range; on the other hand, a substantial increase in the viscosity of the obtained composition is prevented and the handling characteristics of the obtained composition are excellent when the content of component (B) is not more than the upper limit on the indicated range.

An aluminum-based or titanium-based coupling agent of component (C) improves the heat resistance exhibited by the composition and inhibits oil bleeding by this composition. These aluminum-based and titanium-based coupling agents are commercially available. The aluminum-based coupling agents are compounds in which at least one easily hydrolyzable hydrophilic group and at least one hardly hydrolyzable hydrophobic group are bonded to aluminum. And the titanium-based coupling agents are compounds in which at least one easily hydrolyzable hydrophilic group and at least one hardly hydrolyzable hydrophobic group are bonded to titanium.

Alkylacetoacetate aluminum di-isopropylate is an example of the aluminum-based coupling agent while the product available under the PLENACT (registered trademark) AL-M name from Ajinomoto Co., Inc., is an example of the commercially available products, but there is no limitation to the above.

The titanium-based coupling agent can be exemplified by isopropyl tri-isostearoyl titanate, isopropyl tri-n-stearoyl titanate, isopropyl trioctanoyl titanate, isopropyl tridodecylbenzenesulfonyl titanate, isopropyl tris(di-octyl pyrophosphite) titanate, tetra-isopropyl bis(dioctyl phosphite) titanate, tetraoctyl bis(di-tridecyl phosphite) titanate, tetra(2,2-diallyloxymethyl-1-butyl)bis(di-tridecyl)phosphite titanate, bis(dioctyl pyrophosphate)oxyacetate titanate, bis(dioctyl pyrophosphate)ethylene titanate, tris(dioctyl pyrophosphate)ethylene titanate, isopropyl dimethacryl isostearoyl titanate, isopropyl isostearoyl diacryl titanate, isopropyl tri(dioctyl phosphate) titanate, isopropyl tricumylphenyl titanate, isopropyl tri(N-aminoethylaminoethyl) titanate, dicumylphenyloxyacetate titanate, di-isostearoylethylene titanate, isopropyl di-isostearoyl cumylphenyl titanate, isopropyl distearoyl methacryl titanate, isopropyl di-isostearoyl acryl titanate, isopropyl 4-aminobenzenesulfonyl di(dodecylbenzenesulfonyl) titanate, isopropyl trimethacryl titanate, isopropyl di(4-aminobenzoyl)isostearoyl titanate, isopropyl tri(dioctyl pyrophosphate) titanate, isopropyl triacryl titanate, isopropyl tri(N,N-dimethylethylamino) titanate, isopropyl trianthranyl titanate, isopropyl octyl butyl pyrophosphate titanate, isopropyl di(butyl, methylpyrophosphate) titanate, tetra-isopropyl di(dilauroyl phosphite) titanate, di-isopropyloxyacetate titanate, isostearoyl methacryloxyacetate titanate, isostearoyl acryloxyacetate titanate, di(dioctyl phosphate)oxyacetate titanate, 4-aminobenzenesulfonyl dodecylbenzenesulfonyloxyacetate titanate, dimethacryloxyacetate titanate, dicumylphenolateoxyacetate titanate, 4-aminobenzoyl isostearoyloxyacetate titanate, diacryloxyacetate titanate, di(octyl, butyl pyrophosphate)oxyacetate titanate, isostearoyl methacrylethylene titanate, di(dioctyl phosphate)ethylene titanate, 4-aminobenzenesulfonyl dodecylbenzenesulfonylethylene titanate, dimethacrylethylene titanate, 4-aminobenzoyl isostearoylethylene titanate, diacrylethylene titanate, dianthranylethylene titanate, di(butyl, methyl pyrophosphate)ethylene titanate, titanium allyl acetoacetate triisopropoxide, titanium bis(triethanolamine) di-isopropoxide, titanium di-n-butoxide (bis-2,4-pentanedionate), titanium di-isopropoxide bis(tetramethylheptanedionate), titanium di-isopropoxide bis(ethyl acetoacetate), titanium methacryloxyethyl acetoacetate tri-isopropoxide, titanium methylphenoxide, and titanium oxide bis(pentanedionate). The products available under the designations PLENACT (registered trademark) KR ITS, KR 46B, KR 55, KR 41B, KR 138S, KR 238S, 338X, KR 44, and KR 9SA are examples of the commercially available products. However, there is no limitation to the above.

The content of component (C) is in the range from 1 to 100 parts by mass, and is preferably in the range from 1 to 50 parts by mass, and particularly preferably is in the range from 1 to 20 parts by mass, in each case per 100 parts by mass of component (A). The reasons for this are as follows: the obtained composition has excellent heat resistance when the content of component (C) is at least the lower limit on the indicated range; on the other hand, timewise changes in the viscosity of the obtained composition can be inhibited at not more than the upper limit on the indicated range.

The composition may further comprise (D) a silica-based filler. This silica-based filler functions to inhibit slipping off even when the composition is held vertically post-application. Component (D) can be exemplified by finely divided silicas such as fumed silica, precipitated silica, and so forth, and by finely divided silicas as provided by subjecting the surface of the above finely divided filler to a hydrophobic treatment with an organosilicon compound such as an alkoxysilane, chlorosilane, silazane, and so forth. The particle size of component (D) is not particularly limited, but its BET specific surface area is preferably at least 50 m²/g and particularly preferably is at least 100 m²/g.

Although there are no limitations on the content of component (D), the content of component (D) is preferably in the range from 0.1 to 100 parts by mass, and is particularly preferably in the range from 0.5 to 50 parts by mass, in each case per 100 parts by mass of component (A). The reasons for this are as follows: the resistance to slipping off when the obtained composition is held vertically post-application can be further improved when the content of component (D) is at least the lower limit on the indicated range; on the other hand, the obtained composition exhibits excellent handling properties at not more than the upper limit on the indicated range.

The composition may further comprise (E) a silane coupling agent. This silane coupling agent can be exemplified by methyltrimethoxysilane, methyltriethoxysilane, ethyltrimethoxysilane, n-propyltrimethoxysilane, butyltrimethoxysilane, pentyltrimethoxysilane, vinyltrimethoxysilane, vinyltriethoxysilane, methylvinyldimethoxysilane, allyltrimethoxysilane, allylmethyldimethoxysilane, butenyltrimethoxysilane, 3-glycidoxypropyltrimethoxysilane, 3-glycidoxypropylmethyldimethoxysilane, 3-glycidoxypropyltriethoxysilane, 3-methacryloxypropyltrimethoxysilane, 3-methacryloxypropyltriethoxysilane, 3-methacryloxypropymethyldimethoxysilane, 3-acryloxypropyltrimethoxysilane, and 3-acryloxypropylmethyldimethoxysilane.

Although there are no limitations on the content of component (E), the content of component (E) is preferably in the range from 1 to 150 parts by mass, more preferably in the range from 1 to 100 parts by mass, even more preferably in the range from 1 to 50 parts by mass, and particularly preferably in the range from 1 to 30 parts by mass, in each case per 100 parts by mass component (A). The reasons for this are as follows: when the content of component (E) is at least the lower limit on the indicated range, the obtained composition exhibits excellent handling characteristics even when component (B) is present in large amounts and the precipitation and separation of component (B) during storage of the obtained composition can be inhibited even when component (B) is present in large amounts; on the other hand, the component that does not contribute to the surface treatment of component (B) can be held at a small amount at not more than the upper limit on the indicated range.

Insofar as the object of the present invention is not impaired, the composition may contain as an optional component other than those already indicated e.g., a filler such as a fumed titanium oxide; a filler as provided by subjecting the surface of the filler to a hydrophobic treatment with an organosilicon compound; also, a pigment, dye, fluorescent dye, heat stabilizer, flame retardant other than a triazole compound, plasticizer, or adhesion promoter.

There are no limitations on a method of producing the composition, but this composition may be produced, for example, by mixing component (A) with component (B) with heating and thereafter admixing component (C) at room temperature. In a preferred method when the surface of component (B) is to be treated with component (E), components (A), (B), and (E) are mixed with each other with heating and component (C) is thereafter admixed at room temperature. When component (C) is heated while in components (A) and (B), the heat resistance of the obtained composition declines, that is, a reduction occurs in the ability to inhibit slipping off when the obtained composition is held vertically post-application, and as a result the simple presence of component (C) in the composition is preferred.

### EXAMPLES

The thermally conductive silicone grease composition of the present invention is described in detail by examples. The properties given in the examples are the values at 25° C. The properties of the thermally conductive silicone grease compositions were evaluated as follows.

### [Viscosity]

Viscosity of the thermally conductive silicone grease composition was measured by means of a rheometer “Model AR550” from TA Instruments, Ltd. A plate with a diameter of 20 mm was used for the geometry. The viscosity is the value at a shear rate of 10 (1/s).

### [Oil Bleeding]

0.2 cc of the thermally conductive silicone grease composition was applied on a 5 cm×5 cm single-sided ground glass panel from Paltec Test Panels Co., Ltd.; a 1.8 cm×1.8 cm cover glass from Matsunami Glass Ind., Ltd., was placed thereon; and the sample thickness was adjusted to 300 μm using a micrometer from Mitutoyo Corporation. This test specimen was held for 3 days at 25° C., and the oil bleeding was evaluated as the ratio between the diameter of the oil that had bled out from the thermally conductive silicone grease composition and the initial diameter of the thermally conductive silicone grease composition.

### [Heat Resistance]

0.6 cc of the thermally conductive silicone grease composition was sandwiched between a 25×75×1 mm copper test panel from Paltec Test Panels Co., Ltd., and a 25×75×1 mm cover glass from Matsunami Glass Ind., Ltd., and the thickness of the composition was adjusted with a 1 mm spacer. Thermal shock testing (−40° C./125° C./500 cycles) was carried out with this test specimen set vertically, and the presence/absence of sagging by the thermally conductive silicone grease composition was observed.

### [Thermal Conductivity]

Thermal conductivity of the thermally conductive silicone grease composition was measured by means of “QTM-500” from Kyoto Denshi Kogyo Co., Ltd.

### Example 1

100 parts by mass of a dimethylpolysiloxane represented by the following formula:

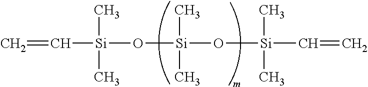

wherein m has a value that provides a viscosity of 2,000 mPa·s, and 2,400 parts by mass of a spherical aluminum oxide powder having an average particle size of 12 μM were preliminarily mixed for 30 minutes at room temperature; this was followed by heating and mixing for 60 minutes at 150° C. under reduced pressure. After then cooling to room temperature, 80 parts by mass of an aluminum-based coupling agent (product name “PLENACT AL-M” from Ajinomoto Co., Ltd.) was admixed to produce a thermally conductive silicone grease composition.

### Example 2

100 parts by mass of a dimethylpolysiloxane represented by the following formula:

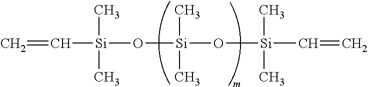

wherein m has a value that provides a viscosity of 12,000 mPa·s, 100 parts by mass of a dimethylpolysiloxane represented by the following formula:

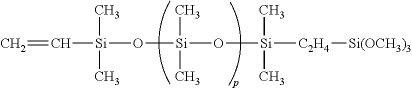

wherein p has a value that provides a viscosity of 20 mPa·s, 4,000 parts by mass of a spherical aluminum oxide powder having an average particle size of 12 μm, and 30 parts by mass of a methyltrimethoxysilane were preliminarily mixed for 30 minutes at room temperature; this was followed by heating and mixing for 60 minutes at 150° C. under reduced pressure. After then cooling to room temperature, 15 parts by mass of an aluminum-based coupling agent (product name “PLENACT AL-M” from Ajinomoto Co., Ltd.) was admixed to produce a thermally conductive silicone grease composition.

### Example 3

100 parts by mass of a dimethylpolysiloxane represented by the following formula:

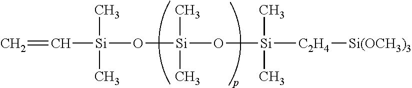

wherein p has a value that provides a viscosity of 20 mPa·s, 2,560 parts by mass of a spherical aluminum oxide powder having an average particle size of 12 μm, 360 parts by mass of an irregularly shaped zinc oxide powder having an average particle size of 0.1 μm, and 10 parts by mass of a methyltrimethoxysilane were preliminarily mixed for 30 minutes at room temperature; this was followed by heating and mixing for 60 minutes at 150° C. under reduced pressure. After then cooling to room temperature, 2.7 parts by mass of a titanium-based coupling agent (product name “PLENACT KR-44” from Ajinomoto Co., Ltd.) was admixed to produce a thermally conductive silicone grease composition.

### Example 4

100 parts by mass of a dimethylpolysiloxane represented by the following formula:

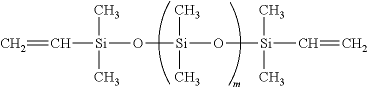

wherein m has a value that provides a viscosity of 400 mPa·s, 500 parts by mass of a spherical aluminum oxide powder having an average particle size of 12 μm, and 10 parts by mass of a fumed silica having a BET specific surface area of 200 m²/g and hydrophobically surface-treated with a hexamethyldisilazane were preliminarily mixed for 30 minutes at room temperature; this was followed by heating and mixing for 60 minutes at 150° C. under reduced pressure. After then cooling to room temperature, 5 parts by mass of an aluminum-based coupling agent (product name “PLENACT AL-M” from Ajinomoto Co., Ltd.) was admixed to produce a thermally conductive silicone grease composition.

### Example 5

100 parts by mass of a dimethylpolysiloxane represented by the following formula:

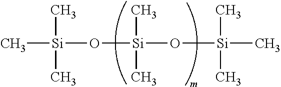

wherein m has a value that provides a viscosity of 300 mPa·s, 650 parts by mass of an irregularly shaped aluminum nitride powder having an average particle size of 3 μm, 5 parts by mass of a dimethylpolysiloxane represented by the following formula:

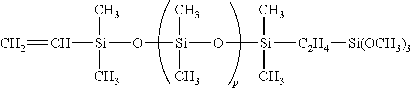

wherein p has a value that provides a viscosity of 20 mPa·s, and 5 parts by mass of a methyltrimethoxysilane were preliminarily mixed for 30 minutes at room temperature; this was followed by heating and mixing for 60 minutes at 150° C. under reduced pressure. After then cooling to room temperature, 10 parts by mass of an aluminum-based coupling agent (product name “PLENACT AL-M” from Ajinomoto Co., Ltd.) was admixed to produce a thermally conductive silicone grease composition.

### Comparative Example 1

100 parts by mass of a dimethylpolysiloxane represented by the following formula:

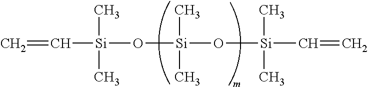

wherein m has a value that provides a viscosity of 2,000 mPa·s, and 2,400 parts by mass of a spherical aluminum oxide powder having an average particle size of 12 μm were preliminarily mixed for 30 minutes at room temperature; this was followed by heating and mixing for 60 minutes at 150° C. under reduced pressure. Subsequent cooling to room temperature yielded a thermally conductive silicone grease composition.

### Comparative Example 2

100 parts by mass of a dimethylpolysiloxane represented by the following formula:

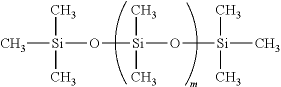

wherein m has a value that provides a viscosity of 300 mPa·s, 650 parts by mass of an irregularly shaped aluminum nitride powder having an average particle size of 3 μm, 5 parts by mass of a dimethylpolysiloxane represented by the following formula:

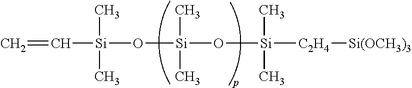

wherein p has a value that provides a viscosity of 20 mPa·s, and 5 parts by mass of a methyltrimethoxysilane were preliminarily mixed for 30 minutes at room temperature; this was followed by heating and mixing for 60 minutes at 150° C. under reduced pressure. Subsequent cooling to room temperature yielded a thermally conductive silicone grease composition.

TABLE 1

| | Classification | | | | | | |
|---|---|---|---|---|---|---|---|
| | | | | | | Comparative | |
| | Examples | | | | | Examples | |
| Item | 1 | 2 | 3 | 4 | 5 | 1 | 2 |
| Viscosity | 520 | 280 | 180 | 210 | 340 | 550 | 380 |
| (Pa · s) | | | | | | | |
| Oil bleeding | 1.0 | 1.1 | 1.2 | 1.2 | 1.0 | 1.8 | 2.1 |
| Heat resistance | no change | | | | | sagging occurred | |
| Thermal | 4.8 | 5.0 | 2.5 | 1.6 | 2.9 | 4.8 | 2.9 |
| conductivity | | | | | | | |
| (W/m · K) | | | | | | | |

### INDUSTRIAL APPLICABILITY

The thermally conductive silicone grease composition of the present invention, because it has excellent heat resistance and reduced oil bleeding, is well suited as a heat-dissipating material for electrical components and electronic components and in particular is well suited as a heat-dissipating material for automotive control units where resistance to slipping off is required even during vertical disposition in a severe temperature environment.

1. A thermally conductive silicone grease composition comprising:
(A) 100 parts by mass of an organopolysiloxane represented by the following general formula: 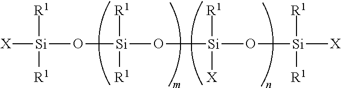
wherein
each R¹ is independently selected from monovalent hydrocarbon groups,
each X is independently selected from monovalent hydrocarbon groups or alkoxysilyl-containing groups represented by the following general formula:
—R²—SiR¹ₐ(OR³)₍₃₋ₐ₎
wherein
R¹ is defined as above,
R² is an oxygen atom or an alkylene group,
R³ is an alkyl group, and
a is an integer ranging from 0 to 2,
m is an integer equal to or greater than 0, and
n is an integer equal to or greater than 0;
(B) 500 to 4,500 parts by mass of a thermally conductive filler; and
(C) 1 to 100 parts by mass of an aluminum-based or titanium-based coupling agent.

2. The thermally conductive silicone grease composition according to claim 1, wherein component (A) has a viscosity ranging from 5 to 100,000 mPa·s at 25° C.

3. The thermally conductive silicone grease composition according to claim 1, wherein component (B) has an average particle size ranging from 0.01 to 100 μm.

4. The thermally conductive silicone grease composition according to claim 1, wherein component (B) is a metal-based powder, a metal oxide-based powder, or a metal nitride-based powder.

5. The thermally conductive silicone grease composition according to claim 1, wherein component (B) is a silver powder, an aluminum powder, an aluminum oxide powder, a zinc oxide powder, or an aluminum nitride powder.

6. The thermally conductive silicone grease composition according to claim 1, further comprising (D) a silica-based filler in an amount of 0.1 to 100 parts by mass per 100 parts by mass of component (A).

7. The thermally conductive silicone grease composition according to claim 1, further comprising (E) a silane coupling agent in an amount of 1 to 150 parts by mass per 100 parts by mass of component (A).

8. The thermally conductive silicone grease composition according to claim 2, wherein component (B) has an average particle size ranging from 0.01 to 100 μm.

9. The thermally conductive silicone grease composition according to claim 1, wherein component (B) is a silver powder, an aluminum powder, an aluminum oxide powder, a zinc oxide powder, or an aluminum nitride powder, and is present in a range from 500 to 3,500 parts by mass.

10. The thermally conductive silicone grease composition according to claim 9, wherein component (C) is alkylacetoacetate aluminum di-isopropylate.

11. The thermally conductive silicone grease composition according to claim 1, wherein component (C) is alkylacetoacetate aluminum di-isopropylate.

12. The thermally conductive silicone grease composition according to claim 9, wherein component (C) is the titanium-based coupling agent, and is present in a range from 1 to 50 parts by mass.

13. The thermally conductive silicone grease composition according to claim 1, wherein component (C) is present in a range from 1 to 20 parts by mass.
